(19) United States
(12) Patent Application Publication
(10) Pub. No.: US 2014/0246365 A1
(43) Pub. Date: Sep. 4, 2014

(54) "UNDERDRAIN FILTER FOR POWER GENERATION AND LIQUID PROCESS FILTRATION VESSELS AND METHOD OF USING THE SAME"

(71) Applicant: Graver Technologies, LLC, Glasgow, DE (US)

(72) Inventors: John McPeak, Mickleton, NJ (US); Gilbert Royal, Middletown, DE (US); Brian Raab, Bel Air, MD (US); Thomas Fremont Arthur Gagnon, Mahomet, IL (US)

(73) Assignee: Graver Technologies, LLC, Glasgow, DE (US)

(21) Appl. No.: 14/193,253

(22) Filed: Feb. 28, 2014

Related U.S. Application Data
(60) Provisional application No. 61/771,479, filed on Mar. 1, 2013.

(51) Int. Cl. C02F 1/00; G21F 9/04; B01D 35/02

(52) U.S. Cl. CPC C02F 1/004; B01D 35/02; G21F 9/04
USPC 210/167.01; 210/490; 210/459; 210/236

(57) ABSTRACT

An underdrain filter or strainer for use with power generation and ion exchange facilities, such as, but not limited to, deep bed demineralizers used in nuclear power plants deep bed ion exchangers. The filter is fabricated from a sintered, stainless steel mesh or wire-cloth filter media having a pore structure with pore size ranging approximately from one micron to two hundred microns. The filter media is composed of a plurality of filter media layers including a perforated inner core bonded to at least one drainage wire mesh, a filtration wire mesh, and a protective wire mesh forming an outer diameter, the layers being diffusion bonded to form a single monolithic laminate.

### BACKGROUND OF THE INVENTION

1. Field of the Invention

This invention relates to apparatus for purifying critical fluids in an adverse environment where improved performance in terms of pressure drop or flow is required or time of replacement is critical and/or exposure to the environment hazardous. More particularly, this invention relates to an underdrain strainer apparatus for removing dissolved and undissolved impurities from liquids such as water and the like, where such dissolved and undissolved impurities originate from liquid process filtration vessels or power generation facilities, and may even be radioactive, as generally occurs with respect to underdrain filtration systems employed in nuclear power plants.

2. Description of Related Art

Generally, the purpose of an underdrain system is to provide support for filtered drainage, including directing fluid through filter media, collecting treated fluid, and channeling it to a retaining reservoir. Then, typically as the filter media becomes dirty, the underdrain is used to evenly distribute backwash fluid used to flush out the solids, although not all systems are designed for efficient backwash.

One of the principal methods employed to remove undissolved solids from water, or other fluids, is to pass the fluid through a mechanical filter, such as a filter screen, filter cloth, filter leaf, or the like. With respect to the removal of dissolved impurities from water or other fluids, the use of ion exchange resins has become well known in the art. Such resins, which may be bead type or powdered type as is known in the art, when contacted by a fluid, exchange free ions between the fluid and the resin. Accordingly, when a fluid is passed through a bed or beds of these ion exchange resins, the ions of the dissolved impurities are captured by the ion exchange resin particles and replaced by more desirable or innocuous ions released by the ion exchange particles to the fluid. Therefore, the undesirable ions in the water are exchanged for desirable or innocuous ions given off by the resin particles. In this manner, a form of filtration and purification is achieved.

As will be recognized by those skilled in the arts, however, particular and unique problems are presented when the fluid contaminants are radioactive. The removal of dissolved and undissolved solids from fluids when such dissolved and undissolved solids are radioactive inevitably results in a build-up of radioactive material within the purification apparatus. Passage of undissolved solids through mechanical filter devices causes a build-up of the undissolved solids on the filter structure with a resultant concentration of radioactivity at the filter. Similarly, the removal of dissolved solids by passage through a demineralizer bed of ion exchange resins also results in a build-up of radioactive materials or activity within the demineralizer bed.

The inaccessibility of an underdrain when installed, and the major part it plays in total filter efficiency and operating cost, make the underdrain a very important part of a power generation facilities' or liquid process filtration vessel's fluid system. This criticality is heightened when the underdrain system entraps impurities, for example, radioactive impurities, or becomes radioactive by exposure to radioactive conditions, and users must access, remove, and substitute replaceable components. There remains a need in the prior art to develop a more efficient underdrain filtration system that lends itself to easy installation and removal, both from a standpoint of ease of maintenance, timeliness of repair and/or reduced exposure to working personnel.

Various underdrain systems have been developed for filter systems that filter water, wastewater, and other critical liquids. The underdrain systems are a key component of a filter system as they receive liquid and/or air throughout virtually all phases of filtering including washing phases and filtration phases. In washing phases, the underdrain typically directs liquid and/or air upwardly through the filter bed to remove impurities trapped in the filter bed during a filtration phase. The liquid and/or air must be uniformly distributed over the filter bed to ensure the filter bed is properly cleaned. In an up flow filter, the underdrain, during the filtration phase, directs influent upwardly through the filter bed so that impurities may be removed therefrom. In a downflow filter, the underdrain receives the effluent and conveys it to a suitable storage location for subsequent use. Because of the key nature of underdrain filters to the operation of the filter system, an underdrain failure often results in shutdown of the filter system for prolonged periods. Consequently, repair and replacement activities must be performed quickly, especially when dealing with radioactive impurities and exposure to radiation during maintenance.

Known in the art are wedge wire screens which are utilized in a broad range of industrial fields as a rugged screen which have little likelihood of clogging owing to their wires with a flat surface and a V-shaped continuous slit. In some instances, these wedge wire screens are recognized as filters which are generally deemed for particular applications to be superior to conventional filters made of mesh-wires and punched plates.

An underdrain filter constructed of wedge wire has an inherently lower flux rate or open area that decreases even further based on increased obstructions on the surface, plugging slots and reducing the flow passage area until total flow blockage is reached. An exploded view of a typical wedge wire assembly is depicted in FIG. 1. Wedge wire 10 has an angled, wedge shape, and is wrapped around a cylindrical structure 12, to form the filter. To keep the system in operation and prevent screen damage, measures such as backwash, airburst, and frequent manual cleaning to keep screens fully open, are generally needed to keep the system in operation. However, in nuclear power generating plants and specialized liquid process filtration vessels, time consuming maintenance and the removal and installation of replaceable devices expose the user to an unwanted environment, which may include radiation.

A wedge wire screen is the solid-liquid separation apparatus of choice for underdrain systems for nuclear power generation. The wedge wire filtering apparatus uses screens having slits of specified dimensions provided among wedge wires, by forming wedge wires of metal wire rods of a wedge shaped section in multiple rows in parallel. This filtering apparatus is widely used in various industrial fields, for the purpose of removing floating matter in wastewater treatment plants, including solid-liquid separation of crude liquid in the treatment process of various industrial waste water in paper pulp industry, food industry, textile industry, chemical industry, and others. FIG. 2 depicts a cross-sectional view of a wedge wire filtration screen used in underdrain systems in the nuclear power industry.

The wedge wire screen forms a filter having closely spaced wedge wire windings defining a permanent filter media by allowing liquid flow through the gaps, in which the outer face of the wedge wire strands are ground away to eliminate the radiused corners on each strand, which corners create a small convergent region intermediate adjacent strands of wedge wire tending to trap solids and clog the filter when particles sizes are present in a range tending to wedge in those regions.

The slit spacing width between wedge wires in a screen device using wedge wires is generally on the order of 0.5 mm (500 microns), but solid matter is likely to deposit and accumulate on the side surfaces of the wedge wires on the back side of the screen, causing clogging of slits, and in these instances, the solid-liquid separation performance may be lowered.

The steel wire making up the screens is relatively thin and is prone to erode. Furthermore, standard screens may collapse under excessive suction. Pressure drop monitoring and automatic control is vital to keep the system in operation. Typically, backwash and airburst mechanisms are initiated to unplug flow slots and let the fluid pass. In the event these mechanisms fail, the screens may collapse. The wedge wire may deform and break, thereby allowing resins to escape downstream and potentially into the reactor vessel. There is a need in the prior art to replace wedge wire underdrain filters with filters capable of performing at least as efficient filtering of solids, while providing for easy maintenance and replacement of filters.

### SUMMARY OF THE INVENTION

Bearing in mind the problems and deficiencies of the prior art, it is therefore an object of the present invention to provide an underdrain filter for a nuclear power generation facility, other power generation facilities, sugar refining manufacturing process facilities, facilities for ion exchange applications, and liquid process filtration vessels, to name a few, that is as efficient as the existing wedge wire filters.

It is another object of the present invention to provide an underdrain filter for a nuclear power generation facility, other power generation facilities, sugar refining manufacturing process facilities, facilities for ion exchange applications, liquid process filtration vessels, and the like, that can be easily replaced in a time efficient manner to reduce maintenance and outage time to reduce cost and exposure of radiation to maintenance personnel.

Still other objects and advantages of the invention will in part be obvious and will in part be apparent from the specification.

The above and other objects, which will be apparent to those skilled in the art, are achieved in the present invention which is directed to an underdrain filter comprising a sintered, stainless steel mesh or wire-cloth filter media having a pore structure with pore size ranging approximately from one micron to two hundred microns, the filter media having a plurality of filter media layers including a perforated inner core bonded to at least one drainage wire mesh, a filtration wire mesh, and a protective wire mesh forming an outer diameter, the layers being diffusion bonded to form a single monolithic laminate.

The underdrain filter may include a quick-release end fitting to facilitate removal and replacement in a radiation environment, a confined space entry environment, or both. The quick-release end fittings may be constructed of rigid stainless steel end fitting couplings.

An adapter for leak proof mounting of the underdrain filter to existing underdrain piping may be employed.

A grooved portion may be formed in each end of the filter to form a mating connection with a removable end fitting.

In a second aspect, the present invention is directed to an underdrain filter system for an ion exchange filtration system comprising: a pipe array; sintered, stainless steel mesh or wire-cloth underdrain filter media for each pipe line or branch in the pipe array having a pore structure with pore size ranging approximately from one micron to two hundred microns, the filter media having a plurality of filter media layers including a perforated inner core bonded to at least one drainage wire mesh, a filtration wire mesh, and a protective wire mesh forming an outer diameter, the layers being diffusion bonded to form a single monolithic laminate; quick-release end fittings to facilitate removal and replacement of the underdrain filter media in an environment requiring a confined space entry; an adapter at each end of the filter for leak proof mounting the underdrain filter to existing underdrain piping; and a grooved portion at each end of the underdrain filter to form a mating connection with a removable end fitting.

In a third aspect, the present invention is directed to an underdrain filter system for a nuclear power generation facility comprising: a pipe array located in a demineralizing vessel of the nuclear power plant; sintered, stainless steel mesh or wire-cloth underdrain filter media for each pipe line or branch having a pore structure with pore size ranging approximately from one micron to two hundred microns, the filter media having a plurality of filter media layers including a perforated inner core bonded to at least one drainage wire mesh, a filtration wire mesh, and a protective wire mesh forming an outer diameter, the layers being diffusion bonded to form a single monolithic laminate; quick-release end fittings to facilitate removal and replacement of the underdrain filter media in a radiation environment; an adapter at each end of the filter for leak proof mounting the underdrain filter to existing underdrain piping; and a grooved portion at each end of the underdrain filter to form a mating connection with a removable end fitting.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is an exploded view of a typical wedge wire filter assembly;

FIG. 2 depicts a cross-sectional view of the wedge wire filter screen of the prior art used in nuclear power generation facilities;

FIG. 3 depicts a graph comparing differential pressure drop as a function of fluid for a sintered stainless steel wire mesh filter versus a wedge wire filter apparatus;

FIG. 4 depicts a bar chart comparing actual flow rates for various installations for a lateral under drain application in a power plant;

FIG. 5 depicts the underdrain filter of the present invention with an attached end fitting design for quick removal and replacement;

FIG. 6 is a partial cross-sectional view of the underdrain filter of the present invention;

FIG. 7 depicts the underdrain filter of the present invention with an attached end fitting design for quick removal and replacement;

FIG. 8 depicts a plan view of an underdrain system for a nuclear power plant;

FIG. 9A depicts a side view of the sintered stainless steel underdrain filter of the present invention;

FIG. 9B is a cross-sectional view of the sintered stainless steel underdrain filter of FIG. 9A;

FIG. 10 depicts a partial elevation view of the sintered stainless steel underdrain system of the present invention deployed in a demineralizer vessel of a nuclear power generation plant; and

FIG. 11 depicts the location and installation of an underdrain filter of the present invention within a nuclear power plant.

### DESCRIPTION OF THE PREFERRED EMBODIMENT(S)

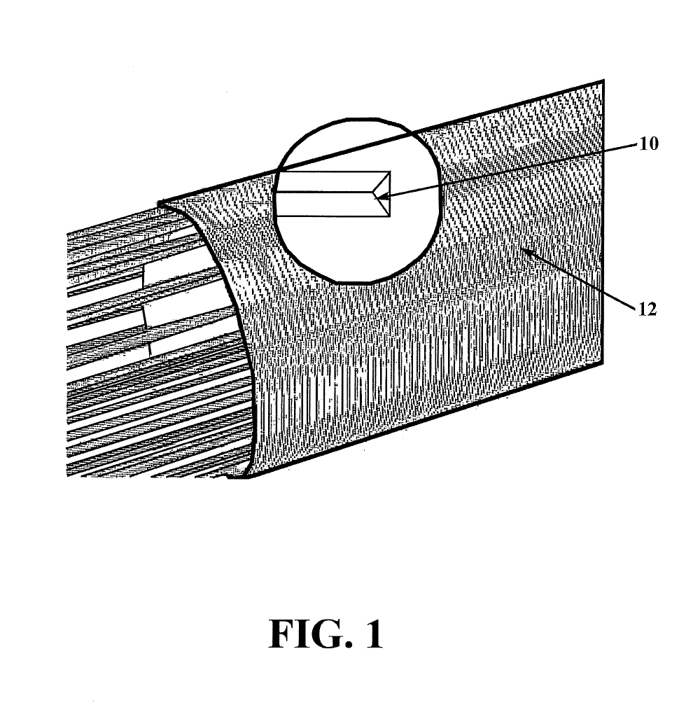

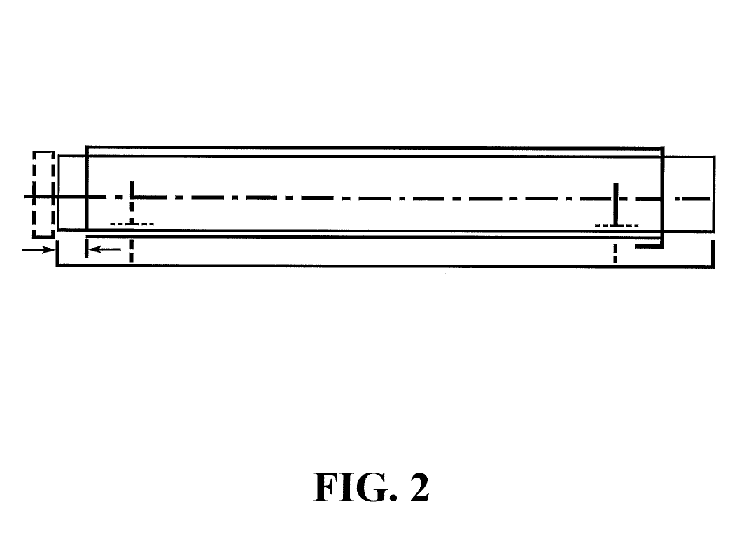

In describing the preferred embodiment of the present invention, reference will be made herein to FIGS. 1-11 of the drawings in which like numerals refer to like features of the invention.

The present invention is employable as a new or replacement underdrain strainer for use with deep bed demineralizers as used in, but not limited to, nuclear power plants deep bed ion exchangers, other power generation facilities, sugar refining manufacturing process facilities, facilities for ion exchange applications, liquid process filtration vessels, and the like. The benefits of an underdrain filter of the present invention over the current prior art wedge wire filters include: 1) an increase in available filtration surface area; 2) ease of installation, which in the case of a nuclear power generating plan installation reduces radiation exposure due to the shorter installation time; 3) a lower operating differential pressure with higher flow rates; 4) instant alignment of the underdrain media to the system configuration; and 5) greater overall utilization and efficiency of the ion exchange resin.

In a preferred embodiment, a sintered stainless steel filter design replaces the current wedge wire filtration device. The sintered stainless steel filter is aligned with pore sizes on the order of about 100 microns, which greatly enhances filtration over the wedge wire design and provides a lower, more manageable pressure drop. Sintered screen technology may vary in construction. It is desirable to ensure that pore sizes on the order of 1-100 microns are achievable for optimum application in underdrain systems for nuclear power plants. One such sintered screen technology that may be employed in the construction of an underdrain filter is identified as Poroplate®, which is advanced by Purolator Facet, Inc., of Greensboro, North Carolina. Generally, in the Poroplate® construction, furnace sintering the metal at over 1100° C. in a controlled atmosphere causes the metal molecules to migrate across contact points of the various layers. In this manner, flocrystalization takes place to form a completely integrated structure.

An advantage of using a sintered stainless steel filter design over the current art in OEM underdrains is the ability to control filtration and provide a system that exhibits less back pressure. The design allows for the open area of the underdrain to include the full circumference of the underdrain design. Sintered stainless metal has more open area than OEM supplied wedge wire typically supplied in these vessels.

A sintered stainless steel mesh or wire-cloth filter allows for durable support for flow distribution and efficient, effective backwashing. This construction further lends itself to lower differential operating pressures and high collapse strength.

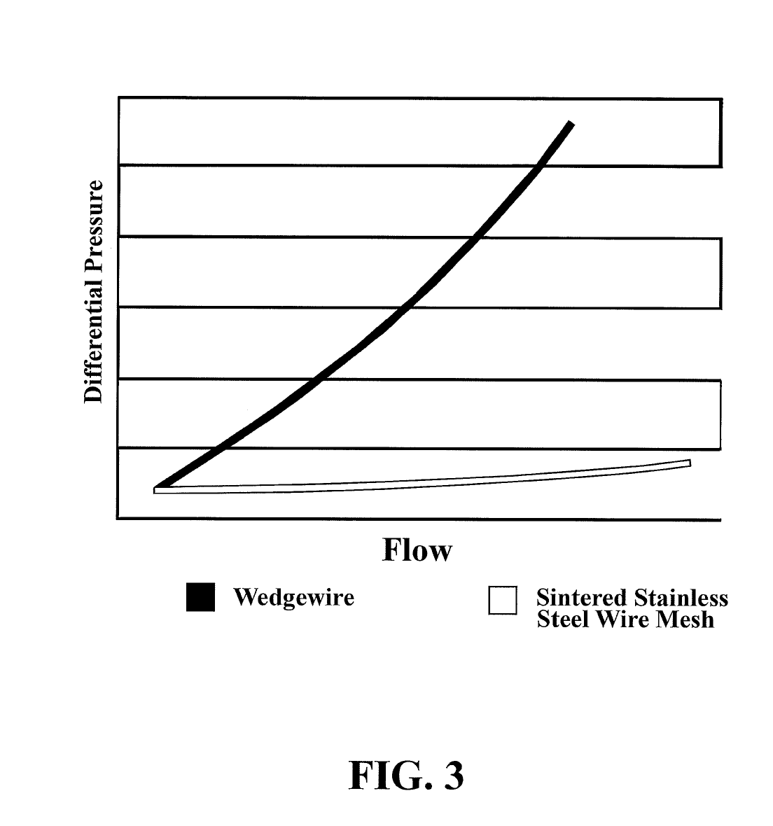

FIG. 3 depicts a graph comparing differential pressure drop as a function of fluid for a sintered stainless steel wire mesh filter (without consideration for the end fitting pressure drop) and a wedge wire filter. The differential pressure drop of the sintered stainless steel wire mesh filter is significantly lower as a function of flow than a wedge wire filter, which exhibits proportional rising differential pressure with rising flow rate. That is, because of the very low open area in the wedge wire media, differential pressure increases almost in direct proportion to flow. The main advantage of employing a sintered stainless steel wire mesh filter for underdrain applications is the lower differential pressure as a function of flow. For example, for a wedge wire underdrain filter utilized in a system with a design flow per vessel of 3500 GPM to a 4000 GPM nominal flow rate, differential pressures would be expected to rise between 4 to 4.5 psi. Replacing the wedge wire filter design with a sintered stainless steel wire mesh filter underdrain having a 200 micron mesh, yields a differential pressure increase of less than 0.5 psi. (Present underdrains are rated at 300 microns.) In this manner, the sintered stainless steel wire mesh design will save approximately 4 psi from the flow increase alone.

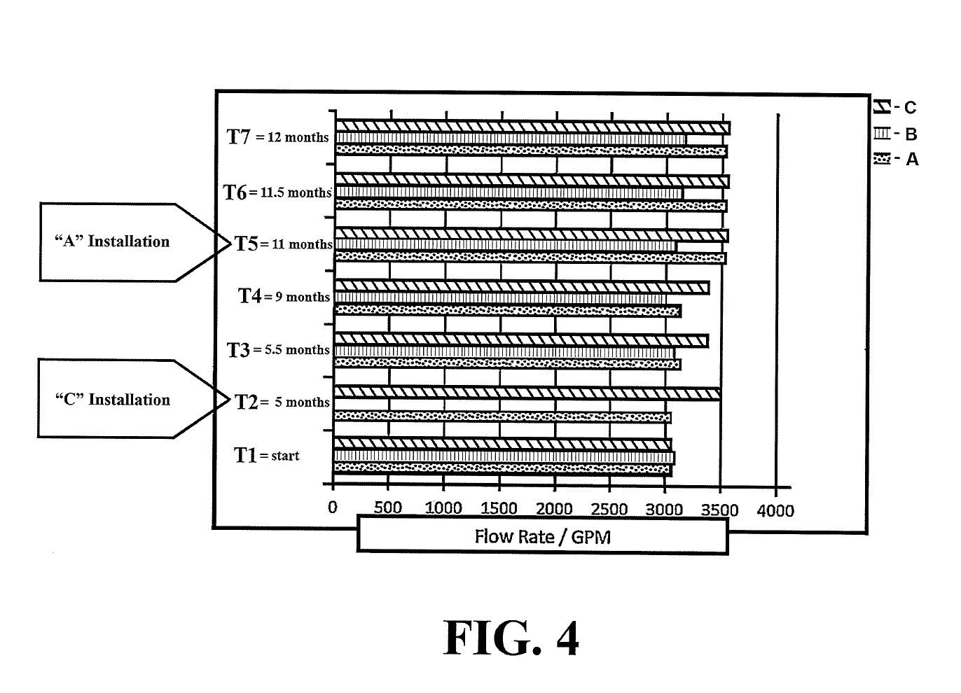

FIG. 4 depicts a bar chart comparing actual flow rates for various installations for a lateral under drain application in a power plant. Two deep bed demineralizer vessels had problematic wedge wire filters replaced with filters employing a sintered stainless steel wire mesh filter. Prior to replacement, the power plant exhibited high differential pressures and bypass, and as a consequence, problems with feed pump suction.

FIG. 4 demonstrates the measured flow rates through three different vessels, A, B, and C over periods of time, accounting for the change in filters. The initial configuration including wedge wire filters for vessels A, B, and C at time T1. The flow rates at that time were measured to be on the order of just over 3000 gpm for all three vessels. At time T2, which is five months from T1, vessel C received a sintered stainless steel wire mesh filter of the present invention. The flow of vessel C is always shown as the top bar in the three-bar group delineation. As measured, the flow rate for vessel C with the new filters immediately increased by approximately 500 gpm to a total flow rate of 3500 gpm. Times T3 and T4 indicate relatively little change in the flow rates. T3 is measured at a time 5.5 months from T1. T4 is measured at a time nine months from T1. At the eleven month mark, T5, vessel A was retrofitted with a sintered stainless steel wire mesh filter of the present invention. The flow of vessel A is always shown as the lowest bar in the three-bar group delineation. At T5, the flow rate of vessel A increased from approximately 3100 gpm to about 3600 gpm, and remained at that flow rate through T6 and T7, which represent the 11.5 month mark and the twelve month mark, respectively.

In contrast, vessel B was not retrofitted and remained unchanged. The flow of vessel B is always shown as the middle or center bar in the three-bar group delineation. The flow rate of vessel B was measured through the times to be about 400 gpm to 500 gpm lower than the retrofitted vessels.

The data indicates a throughput increase of approximately five percent (5%) when new underdrain filters are installed, with lower differential pressures realized (up to 5 psid savings in each retrofitted vessel).

The underdrain preferably includes a three-quarter inch diameter pipe welded vertically to the blind end. The underdrain filter of the present invention is preferably manufactured by a diffusion bonding process. High quality wire cloth layers are sheared and laid upon a custom perforated sheet of stainless steel, preferably, but not limited to, TINS S31603 stainless steel. The filtration layer is designed for 200 micron absolute filtration although other pore sizes may be desirable depending upon the specific application and the type of contaminants requiring filtration.

This composite is diffusion bonded at temperatures in excess of 2000° F. to form a single monolithic laminate. The wire mesh material is sheared to exacting widths to ensure uniform and consistent roundness after forming. The sheared wire mesh blank is formed into a tube using a two-stage cold forming process. An automated Jetline Gas Tungsten Arc Welder (GTAW) is used for seam welding with filler metal addition for its construction. The ferrules and end fittings are preferably attached utilizing the same type of welding method.

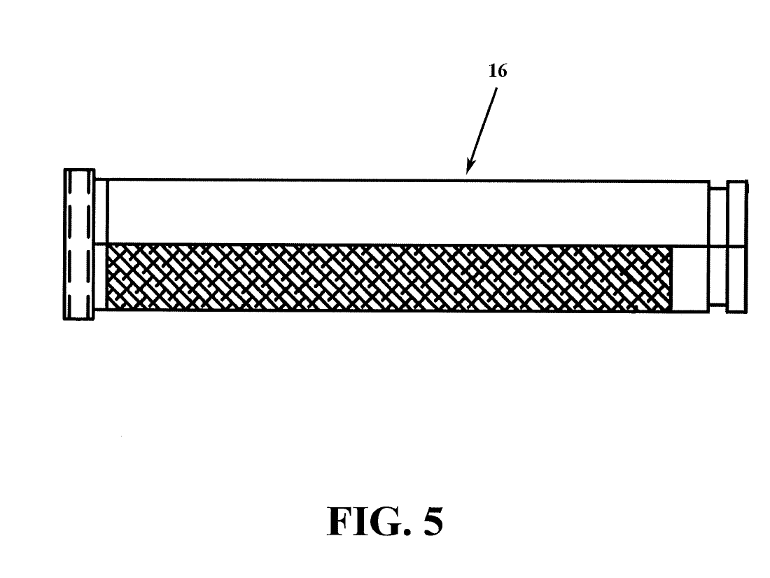

Once fabricated, each lateral is bubble-point tested and ultrasonically cleaned in a halide-free solution. FIG. 5 depicts a partial view of the sintered stainless steel wire mesh filter 16 of the present invention.

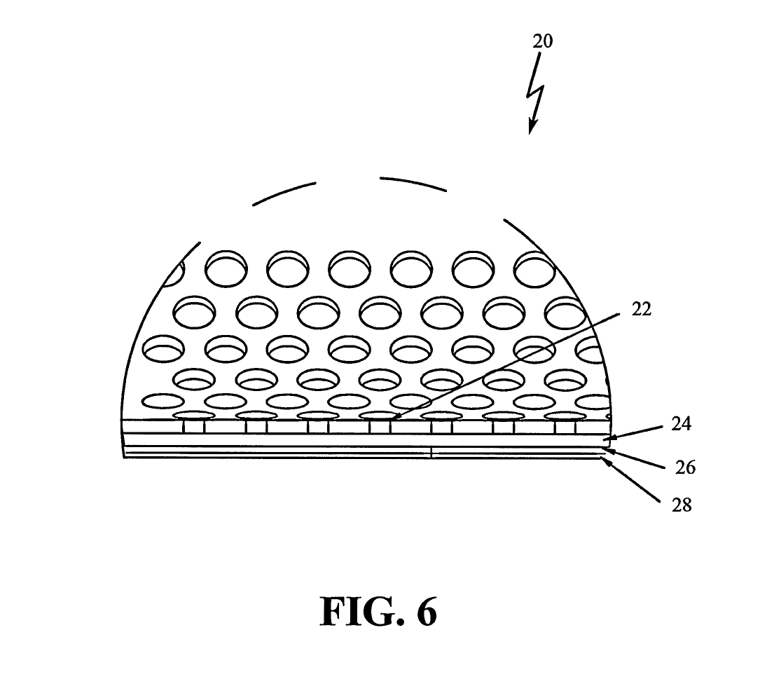

FIG. 6 is a partial cross-sectional view of the underdrain filter 20 of the present invention. A five layer, diffusion bonded filter is sintered into a composite laminate. As depicted, a perforated inner core 22 is bonded to preferably more than one drainage meshes 24, followed by a filtration mesh 26, and a protective mesh 28 for the outer diameter.

This image shows a cross section of the sintered stainless steel filter media. Fine mesh captures contaminants on the upstream surface. Downstream support layers provide open flow channels for low differential pressure, high flow rates and long filtration cycles. Advantageously, this media backflushes well, yielding like-new filter elements after each clean cycle.

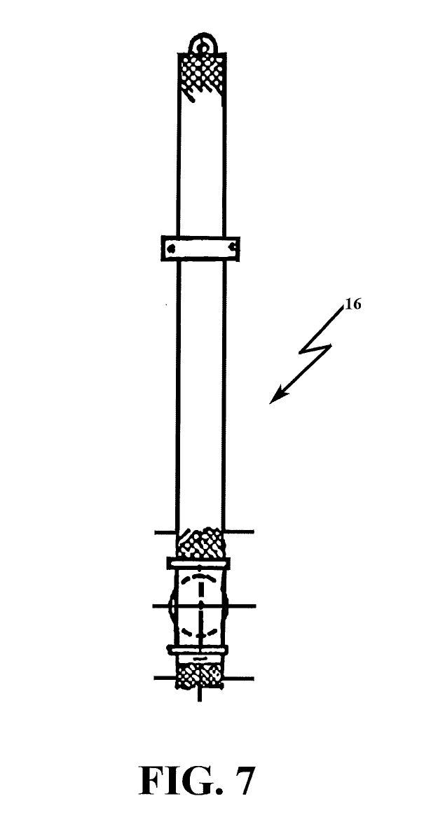

As noted, quick replacement and installation is important to reduce environmental exposure which could include radiation exposure of maintenance personnel. In a preferred embodiment, the ease of installation is facilitated by combining a quick connect end fitting with the sintered stainless steel wire mesh filter underdrain. One such end fitting used in industry is a Victaulic® end fitting. These preferred end fittings are cast of stainless steel or durable ductile iron to precise tolerances. Generally, the fittings or couplings are supplied with grooves to permit fast installation without field preparation. A preferred grooved fitting design permits flexibility for easy alignment. The coupling may be rigid or flexible. Rigid couplings include a pad which constricts the housing keys into a groove around the full circumference to create a rigid joint. These rigid couplings provide a rigid joint allowing no expansion, contraction, or linear movement. Standard flexible grooved-type couplings allow controlled angular, linear, and rotational movement at each joint to accommodate expansion, contraction, settling, vibration, noise, and other piping system movement. FIG. 7 depicts the underdrain filter 16 of the present invention with an attached end fitting design for quick removal and replacement;

End fittings, such as Victaulic® end fittings, allow for faster installation and help facilitate installation and removal under DOE protocol. The admonition to keep exposures As Low As is Reasonably Achievable (ALARA) has been the traditional position of the radiological protection community for several decades. ALARA is a nuclear power plant policy that is associated with a system of dose limitations consisting of three parts, including: (1) justification (no practice causing exposures of persons to radiation shall be adopted unless its introduction produces a positive net benefit, insomuch as practices should not cause more harm than they do good); (2) optimization (all exposures shall be kept as low as is reasonably achievable, economic and social factors being taken into account); and (3) dose limits (the dose equivalent to individuals shall not exceed the limits recommended for the appropriate circumstances). It is understood that the ALARA process is most effective when it is applied in the design of new facilities that have potential for exposing workers and members of the general public. Consequently, the present invention's introduction of a more efficient underdrain filtering system that reduces exposure time for installation, repair, and removal is in concert with the ALARA standards promulgated by the nuclear power industry.

Change out of typical NPT pipe threads takes considerably time. The present invention allows for the quick installation of the new underdrain strainers, which may be expeditiously clamped to the outlet piping, thus lending to an ALARA approved design. However, the invention is not limited to nuclear power plant underdrain configurations as the claims of faster installation combined with more open area are also needed in non-nuclear applications.

It is envisioned that the present invention would be employed for all problematic wedge wire ion exchange or other media type underdrains in nuclear power, fossil power, sugar refining, and all other underdrain installations.

The underdrain laterals include stainless steel threaded adapters that are typically installable in the 2½″, 3″ and 4″ NPT diameter pipe fittings located in the bottom of the nuclear power generator vessel. A threaded adapter will end in a rigid end fitting, preferably a stainless steel end fitting coupling, such as the Rigid Victaulic® or the like. A certified EPDM gasket is provided to seal the connection to the underdrain that is free of sulfates, chlorides, or sodium. If the design is employed for drinking water usage, the underdrain filter may be NSF 61 certified.

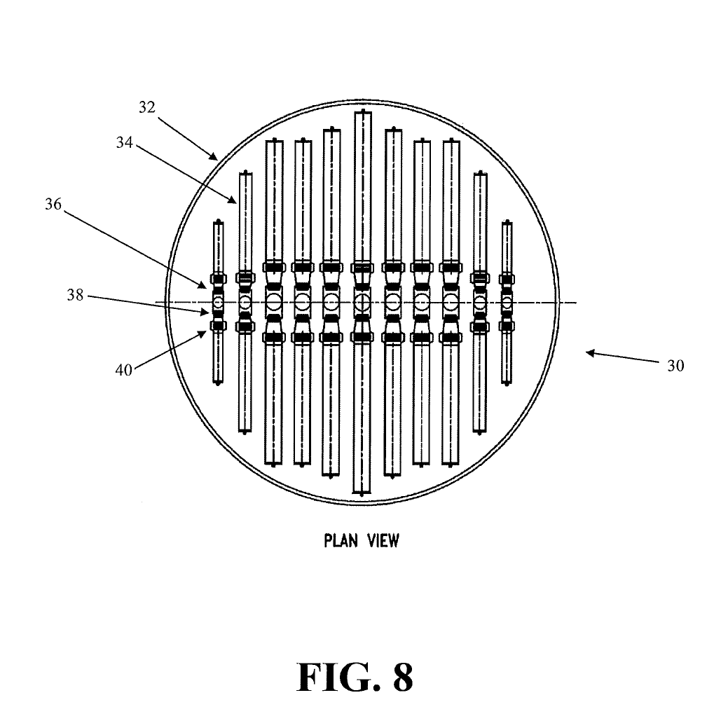

FIG. 8 depicts a plan view of an underdrain system 30 for a nuclear power plant. The underdrain system is housed in an existing demineralizer 32. In a preferred embodiment, ¾″ pipe 34 is welded to the underdrain and used for leveling. The sintered stainless steel filter design 36 is attached to the underdrain system using quick release rigid coupling end fittings 38. An NPT adapter 40 secures the attachment in a leak proof manner.

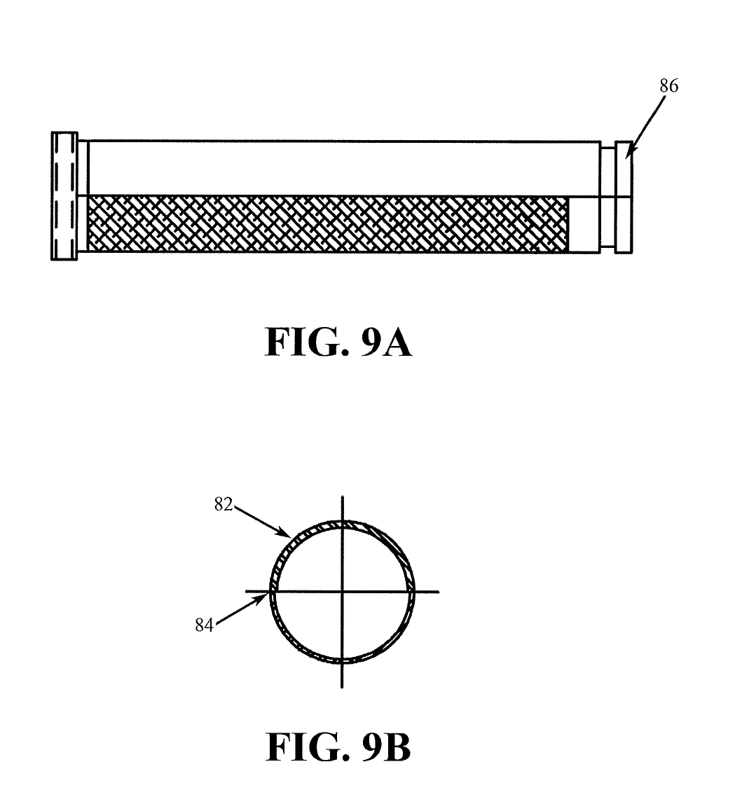

FIG. 9A is a side view of the sintered stainless steel underdrain filter of the present invention. The underdrain filter 80 includes a pipe 82 with weld points 84 and an adapter nipple 86 to facilitate installation and removal at the end fitting. FIG. 9B is a cross-sectional view of the sintered stainless steel underdrain filter of FIG. 9A.

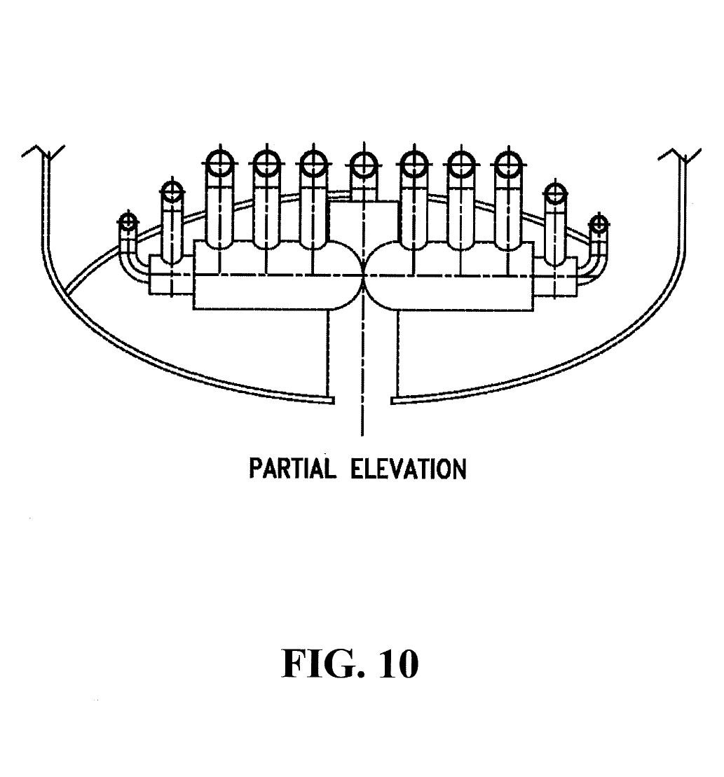

FIG. 10 depicts a partial elevation view of the sintered stainless steel underdrain system of the present invention deployed in a demineralizer vessel of a nuclear power generation plant.

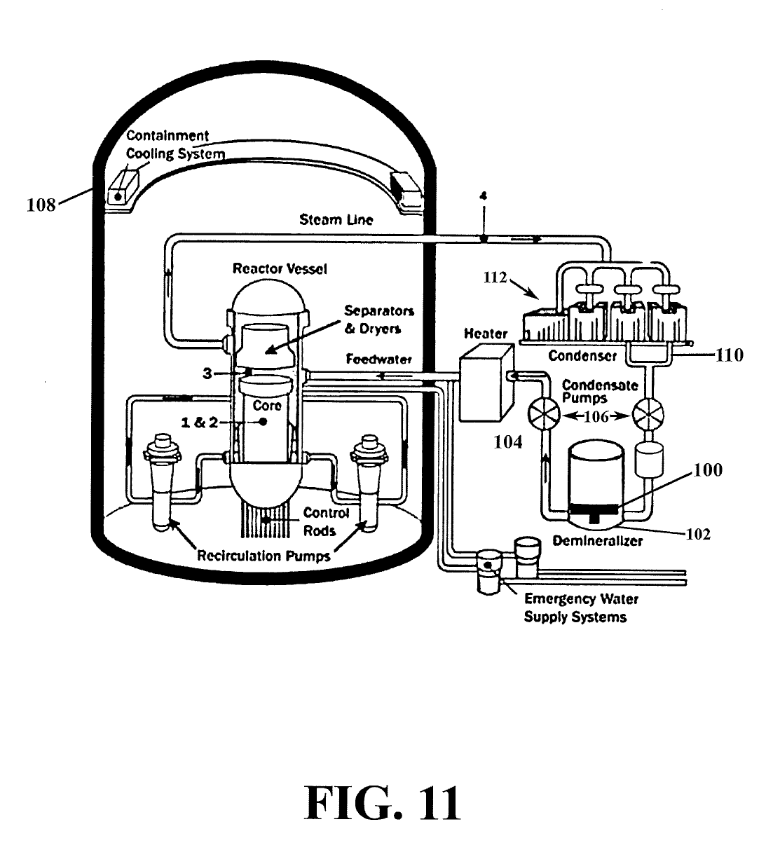

FIG. 11 depicts the location and installation of an underdrain filter of the present invention within a nuclear power plant. Underdrain filters 100 are installed within a demineralizer 102, which is in fluid communication with feed pumps 104 and condensate pumps 106, as well as the containment cooling system 108 and condenser 110 of turbine generator 112.

The present invention is directed towards replacing existing wire wedge filtration devices currently being used in power generating plants, sugar refining plants, and ion exchange facilities, to name a few, with a sintered stainless steel multilayer filter mesh. This substitution will yield lower initial pressure drop; longer on-stream life; reduced labor required to change out filters; fewer elements required for new installations; reduced operator exposure to hazardous chemicals; and reduced disposal of hazardous materials. It is especially useful in facilities having confined space entries since it expedites the removal and replacement of existing, spent filters.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An underdrain filter comprising a sintered, stainless steel mesh or wire-cloth filter media having a pore structure with pore size ranging approximately from one micron to two hundred microns, said filter media having a plurality of filter media layers including a perforated inner core bonded to at least one drainage wire mesh, a filtration wire mesh, and a protective wire mesh forming an outer diameter, said layers being diffusion bonded to form a single monolithic laminate.

2. The underdrain filter of claim 1 including quick-release end fittings to facilitate removal and replacement in a radiation environment, a confined space entry environment, or both.

3. The underdrain filter of claim 1 including an adapter for leak proof mounting said underdrain filter to existing underdrain piping.

4. The underdrain filter of claim 2 wherein said quick-release end fittings include rigid stainless steel end fitting couplings.

5. The underdrain filter of claim 1 including a grooved portion in each end of said filter to form a mating connection with a removable end fitting.

6. An underdrain filter system for a filtration system comprising:
a pipe array;
sintered, stainless steel mesh or wire-cloth underdrain filter media for each pipe line or branch in said pipe array having a pore structure with pore size ranging approximately from one micron to two hundred microns, said filter media having a plurality of filter media layers including a perforated inner core bonded to at least one drainage wire mesh, a filtration wire mesh, and a protective wire mesh forming an outer diameter, said layers being diffusion bonded to form a single monolithic laminate;
quick-release end fittings to facilitate removal and replacement of said underdrain filter media in an environment requiring a confined space entry;
an adapter at each end of said filter for leak proof mounting said underdrain filter to existing underdrain piping; and
a grooved portion at each end of said underdrain filter to form a mating connection with a removable end fitting.

7. The underdrain filter of claim 6 wherein said quick-release end fittings comprise rigid stainless steel end fitting couplings.

8. The underdrain filter of claim 6 including an adapter for leak proof mounting said underdrain filter to existing underdrain piping.

9. The underdrain filter of claim 6 including a grooved portion in each end of said filter to form a mating connection with a removable end fitting.

10. The underdrain filter of claim 6 wherein said filtration system includes a nuclear power generation facility, other power generation facility, a sugar refining manufacturing process facility, a facility for ion exchange applications, or a liquid process filtration vessel.

11. An underdrain filter system for a nuclear power generation facility comprising:
a pipe array located in a demineralizing vessel of said nuclear power plant;
sintered, stainless steel mesh or wire-cloth underdrain filter media for each pipe line or branch having a pore structure with pore size ranging approximately from one micron to two hundred microns, said filter media having a plurality of filter media layers including a perforated inner core bonded to at least one drainage wire mesh, a filtration wire mesh, and a protective wire mesh forming an outer diameter, said layers being diffusion bonded to form a single monolithic laminate;
quick-release end fittings to facilitate removal and replacement of said underdrain filter media in a radiation environment;
an adapter at each end of said filter for leak proof mounting said underdrain filter to existing underdrain piping; and
a grooved portion at each end of said underdrain filter to form a mating connection with a removable end fitting.
